(19) United States
(12) Patent Application Publication
(10) Pub. No.: US 2024/0298342 A1
(43) Pub. Date: Sep. 5, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/659,028

(22) Filed: May 9, 2024

Related U.S. Application Data
(63) Continuation of application No. PCT/CN2022/130487, filed on Nov. 8, 2022.

(30) Foreign Application Priority Data
Nov. 22, 2021 (CN) 202111383822.9

(51) Int. Cl. H04W 72/541; H04L 5/00; H04W 72/0446; H04W 72/0453; H04W 72/1273

(52) U.S. Cl. CPC H04W 72/541; H04L 5/0051; H04W 72/0446; H04W 72/0453; H04W 72/1273

(57) ABSTRACT

A node first receives a first information block, the first information block is used to determine a target time-frequency resource and a first time-frequency resource set, the first time-frequency resource set comprises K1 first-type time-frequency resources, the target time-frequency resource is associated with each of the K1 first-type time-frequency resources; then transmits a first measurement information set; an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set. The present application improves the channel and interference measurement method under full duplex, thereby optimizing the system performance.

### CROSS REFERENCE TO RELATED APPLICATIONS

The present application is the continuation of the international patent application No. PCT/CN2022/130487, filed on Nov. 8, 2022, and claims the priority benefit of Chinese Patent Application No. 202111383822.9, filed on Nov. 22, 2021, the full disclosure of which is incorporated herein by reference.

### BACKGROUND

### Technical Field

The present application relates to transmission methods and devices in wireless communication systems, and in particular to a transmission scheme and device for a measurement based on a flexible transmission direction configuration in wireless communications.

### Related Art

Application scenarios of future wireless communication systems are becoming increasingly diversified, and different application scenarios have different performance demands on systems. In order to meet different performance requirements of various application scenarios, it was decided at 3rd Generation Partner Project (3GPP) Radio Access Network (RAN) #72th plenary that a study on New Radio (NR), or what is called Fifth Generation (5G) shall be conducted. The work item of NR was approved at 3GPP RAN #75th plenary to standardize NR. A Study Item (SI) and a Work Item (WI) of NR Rel-17 was decided to start at 3GPP RAN #86th plenary, and it is anticipated that an SI and WI of NR Rel-18 will be approved at 3GPP RAN #94e-th plenary.

In NR technology, enhanced Mobile BroadBand (eMBB), Ultra-reliable and Low Latency Communications (URLLC), and massive Machine Type Communications (mMTC) are the three main application scenarios. In NR Rel-16 system, the main difference between Long-Term Evolution (LTE) and LTE-A frame structure is that symbols in a slot can be configured as Downlink, Uplink and Flexible. For symbols configured as “Flexible”, the terminal will receive Downlink on the symbol, and the symbol can also be used for Uplink scheduling. The above methods are more flexible than LTE and LTE-A systems.

### SUMMARY

In the existing NR system, the base stations can interact through an Xn Interface. In the future Full Duplex system, considering the benefits of Spatial Domain Duplex and the use of large-scale antennas, the base stations can interact through a radio interface to improve the timeliness and efficiency of interaction, so as to improve the performance gains brought by the coordinated scheduling and joint transmission. Meanwhile, in existing systems, CQI (Channel Quality Indicator) is a type of CSI (Channel Status Information); in the traditional CQI method, resources used for channel measurement (such as CSI-Resource) correspond one-to-one with resources used for interference measurement (such as CSI-Resource). Inventors have found through researches that for given channel measurement resources, if the base station wants to acquire channel state information under multiple interference assumptions, multiple CQIs need to be fed back by the UE, and such an approach wastes radio resources. However, in full duplex systems, when the base stations interact with each other through a radio interface, the traditional Uu interface and the potential V2X (Vehicle-to-Everything) communications occupying Uu interface uplink resources will be interfered.

The present application discloses a solution to the problem incurred by the interaction between base stations through a radio interface in a full duplex scenario. It should be noted that in the description of the present application, flexible duplex mode is only used as a typical application scenario or example; the present application is also applicable to other scenarios confronting similar problems (such as scenarios with a change in the link direction, or scenarios that require more accurate channel and interference measurements due to more complex interference situations, or base stations or UEs with stronger capabilities, such as scenarios supporting full duplex at same frequency, or for different application scenarios, such as eMBB and URLLC), where similar technical effects can be achieved. Additionally, the adoption of a unified solution for various scenarios, including but not limited to scenarios of eMBB and URLLC, contributes to the reduction of hardware complexity and costs. If no conflict is incurred, embodiments in a first node in the present application and the characteristics of the embodiments are also applicable to a second node, and vice versa. Particularly, for interpretations of the terminology, nouns, functions and variants (if not specified) in the present application, refer to definitions given in Technical Specification (TS) 36 series, TS38 series and TS37 series of 3GPP specification protocols.

The present application provides a method in a first node for wireless communications, comprising:
receiving a first information block, the first information block being used to determine a target time-frequency resource and a first time-frequency resource set, the first time-frequency resource set comprising K1 first-type time-frequency resources, the target time-frequency resource being associated with each of the K1 first-type time-frequency resources; and
transmitting a first measurement information set;
herein, an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

In one embodiment, one feature of the above method is in: compared with a traditional one-to-one relation between reference signals used for interference measurement and reference signals used for channel measurement, reference signals used for interference measurement and reference signals used for channel measurement in the above method is one-to-many relation, thus improving the configuration flexibility and measurement accuracy to cope with different interference scenarios.

In one embodiment, another feature of the above method is in: the target first-type time-frequency resource can be used for multiple types of interference measurements, for example for measurements in neighboring cells, or for measurements on non-cellular links, or for measurements of radio signals transmitted on an Xn interface, or for measurements of new interference due to the introduction of new technologies in future systems, thereby improving the overall system performance.

According to one aspect of the present application, the first information block is used to determine a second time-frequency resource set, the second time-frequency resource set comprises K1 second-type time-frequency resources, and the K1 first-type time-frequency resources are respectively associated with the K1 second-type time-frequency resources; the target first-type time-frequency resource is associated with a target second-type time-frequency resource in the K1 second-type time-frequency resources, and an interference measurement performed on the target second-type time-frequency resource is used to determine the first measurement information set.

In one embodiment, one feature of the above method is in: the K1 first-type time-frequency resources and the K1 first-type time-frequency resources correspond to traditional one-to-one corresponding reference signals used for interference measurement and reference signals used for channel measurement, while the target time-frequency resources are newly added reference signal resources used for measurements other than traditional channels and interference measurements.

According to one aspect of the present application, a value range of the first power offset is a first set, the first set is one of a first candidate value set and a second candidate value set, and the first candidate value set is different from the second candidate value set.

In one embodiment, one feature of the above method is in: configuring independent and multiple sets of power parameters for a reference signal transmitted in the target time-frequency resource to distinguish it from existing power parameters, thereby ensuring configuration flexibility to adapt to different interference situations.

According to one aspect of the present application, the first set is related to a type of resources occupied by a first reference time-frequency resource; the first reference time-frequency resource and the first time-frequency resource are QCLed.

In one embodiment, one feature of the above method is in: types of resources occupied by the first reference time-frequency resource are different, thus the interference situations corresponding to the target time-frequency resource are also different, therefore, it is necessary to adjust power of a reference signal transmitted in the target time-frequency resource to cope with different scenarios.

According to one aspect of the present application, a value range of the first power offset value is a first candidate value set, the first information block also indicates a target power offset value, the target power offset value indicates a power difference of a reference signal transmitted in the target first-type time-frequency resource and a PDSCH (Physical Downlink Shared Channel), and a value range of the target power offset value is a second candidate value set; the first candidate value set is different from the second candidate value set.

In one embodiment, one feature of the above method is in: the first candidate value set is newly configured and used for power adjustment of a reference signal transmitted in the target time-frequency resource, while the second candidate value set is traditional power adjusted.

According to one aspect of the present application, the K1 first-type time-frequency resources comprises at least one periodic non-zero power CSI-RS (Channel-State Information Reference Signals) resource, compared to any the periodic Non Zero Power (NZP) CSI-RS resource in the K1 first-type time-frequency resources, configuration information of the target time-frequency resource indicated by the first information block lacks a first field, and the first field is used to indicate QCL (Quasi co-location) parameters.

In one embodiment, one feature of the above method is in: a beam corresponding to a reference signal sent in the target time-frequency resource is not used for scheduling a data channel, but only for interference measurement, and thus the reference signal transmitted in the target time-frequency resource is not associated with a TCI-State ID.

According to one aspect of the present application, comprising:
receiving a first signal and K1 first-type signals;
herein, the first signal occupies the target time-frequency resource, and the K1 first-type signals occupy the K1 first-type time-frequency resources respectively.

According to one aspect of the present application, comprising:
receiving K1 second-type signals;
herein, the K1 second-type signals respectively occupy the K1 second-type time-frequency resources.

According to one aspect of the present application, comprising:
determining the target first-type time-frequency resource from the K1 first-type time-frequency resources;
herein, the target first-type time-frequency resource is a first-type time-frequency resource producing a strongest interference amount to a radio signal transmitted in the target time-frequency resource measured among the K1 first-type time-frequency resources; the first resource indication is used to indicate the target candidate resource set.

In one embodiment, one technical feature of the above method is in: only reporting a first-type time-frequency resource that is most affected by interference, thereby reducing the signaling overhead and improving the spectrum efficiency.

The present application provides a method in a second node for wireless communications, comprising:
transmitting a first information block, the first information block being used to determine a target time-frequency resource and a first time-frequency resource set, the first time-frequency resource set comprising K1 first-type time-frequency resources, the target time-frequency resource being associated with each of the K1 first-type time-frequency resources; and
receiving a first measurement information set;
herein, an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

According to one aspect of the present application, the first information block is used to determine a second time-frequency resource set, the second time-frequency resource set comprises K1 second-type time-frequency resources, and the K1 first-type time-frequency resources are respectively associated with the K1 second-type time-frequency resources; the target first-type time-frequency resource is associated with a target second-type time-frequency resource in the K1 second-type time-frequency resources, and an interference measurement performed on the target second-type time-frequency resource is used to determine the first measurement information set.

According to one aspect of the present application, a value range of the first power offset is a first set, the first set is one of a first candidate value set and a second candidate value set, and the first candidate value set is different from the second candidate value set.

According to one aspect of the present application, the first set is related to a type of resources occupied by a first reference time-frequency resource; the first reference time-frequency resource and the first time-frequency resource are QCLed.

According to one aspect of the present application, a value range of the first power offset value is a first candidate value set, the first information block also indicates a target power offset value, the target power offset value indicates a power difference of a reference signal transmitted in the target first-type time-frequency resource and a PDSCH, and a value range of the target power offset value is a second candidate value set; the first candidate value set is different from the second candidate value set.

According to one aspect of the present application, the K1 first-type time-frequency resources comprises at least one periodic NZP CSI-RS resource, compared to any the periodic NZP CSI-RS resource in the K1 first-type time-frequency resources, configuration information of the target time-frequency resource indicated by the first information block lacks a first field, and the first field is used to indicate QCL parameters.

According to one aspect of the present application, the second node determines a type of resources occupied by the first reference time-frequency resource on its own.

According to one aspect of the present application, the second node determines a type of resources occupied by the first reference time-frequency resource based on Xn interaction information from other nodes.

In one embodiment, the other nodes comprise a base station.

In one embodiment, the Xn interaction information is transmitted through a backhaul link.

In one embodiment, the Xn interaction information is transmitted through a wired link.

According to one aspect of the present application, the second node determines scheduling of the first node based on the first measurement information set.

According to one aspect of the present application, the second node determines a resource set used for V2X configured for the first node based on the first measurement information set.

According to one aspect of the present application, the second node determines a resource pool used for V2X configured for the first node based on the first measurement information set.

According to one aspect of the present application, the second node determines QCL parameters of the first node used for V2X according to the first measurement information set.

According to one aspect of the present application, comprising:
transmitting a first signal and K1 first-type signals;
herein, the first signal occupies the target time-frequency resource, and the K1 first-type signals occupy the K1 first-type time-frequency resources respectively.

According to one aspect of the present application, comprising:
transmitting K1 second-type signals;
herein, the K1 second-type signals respectively occupy the K1 second-type time-frequency resources.

The present application provides a first node for wireless communications, comprising:
a first receiver, receiving a first information block, the first information block being used to determine a target time-frequency resource and a first time-frequency resource set, the first time-frequency resource set comprising K1 first-type time-frequency resources, the target time-frequency resource being associated with each of the K1 first-type time-frequency resources; and
a first transmitter, transmitting a first measurement information set;
herein, an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

The present application provides a second node for wireless communications, comprising:
a second transmitter, transmitting a first information block, the first information block being used to determine a target time-frequency resource and a first time-frequency resource set, the first time-frequency resource set comprising K1 first-type time-frequency resources, the target time-frequency resource being associated with each of the K1 first-type time-frequency resources; and
a second receiver, receiving a first measurement information set;
herein, an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of a first information block according to one embodiment of the present application;

FIG. 6 illustrates a schematic diagram of a target signal and K1 first-type signals according to one embodiment of the present application;

FIG. 7 illustrates a schematic diagram of K1 second-type signals according to one embodiment of the present application;

FIG. 8 illustrates a flowchart for determining a target first-type time-frequency resource according to one embodiment of the present application;

FIG. 9 illustrates a schematic diagram of determining a first measurement information set according to one embodiment of the present application;

FIG. 10 illustrates a schematic diagram of K1 second-type signals according to one embodiment of the present application;

FIG. 11 illustrates a schematic diagram of a first candidate value set and a second candidate value set according to one embodiment of the present application;

FIG. 12 illustrates a schematic diagram of a first information block according to one embodiment of the present application;

FIG. 13 illustrates a structure block diagram of a processor in a first node according to one embodiment of the present application;

FIG. 14 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

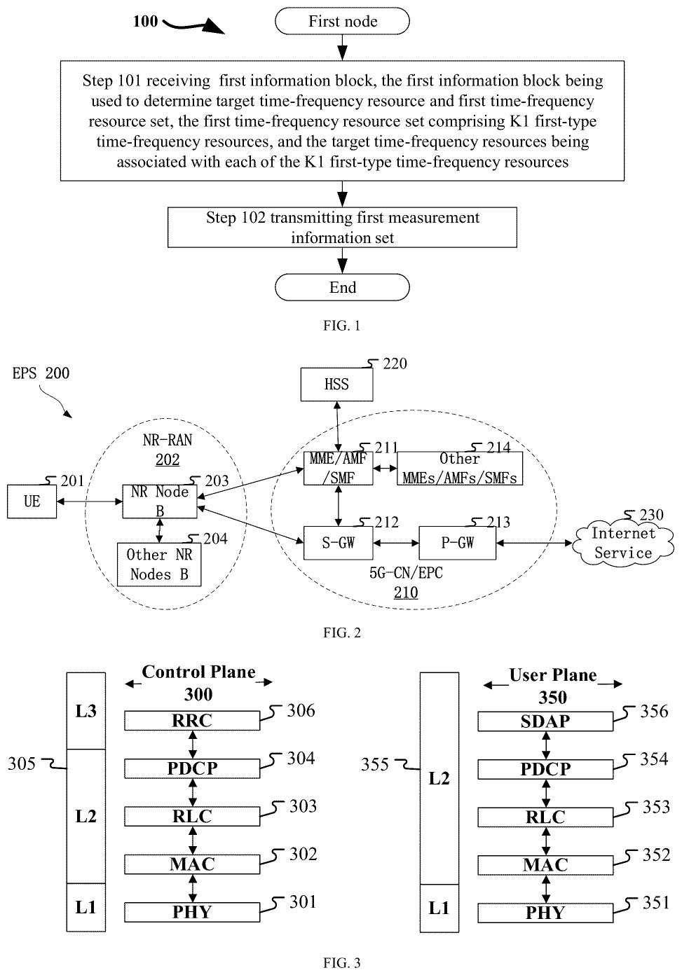

Embodiment 1 illustrates a flowchart of the processing of a first node, as shown in FIG. 1. In step 100 illustrated by FIG. 1, each box represents a step. In embodiment 1, the first node in the present application receives a first information block in step 101, the first information block is used to determine a target time-frequency resource and a first time-frequency resource set, the first time-frequency resource set comprises K1 first-type time-frequency resources, the target time-frequency resource is associated with each of the K1 first-type time-frequency resources; transmits a first measurement information set in step 102.

In embodiment 1, an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

In one embodiment, the first information block is transmitted through a Radio Resource Control (RRC) signaling.

In one embodiment, the first information block is an RRC IE (Information Element).

In one embodiment, the first information block is a field in an RRC IE.

In one embodiment, an RRC IE bearing the first information block is an NZP-CSI-RS-Resource IE.

In one embodiment, an RRC IE bearing the first information block is a CSI-ReportConfig IE.

In one embodiment, a name of an RRC IE bearing the first information block comprises NZP (Non Zero Power).

In one embodiment, a name of an RRC IE bearing the first information block comprises CSI-RS.

In one embodiment, a name of an RRC IE bearing the first information block comprises CSI-Report.

In one embodiment, a name of an RRC IE bearing the first information block comprises ReportConfig.

In one embodiment, the first information block is used to indicate time-frequency resources occupied by the target time-frequency resource.

In one embodiment, the first information block is used to indicate a CSI-ResourceConfigId adopted by a reference signal transmitted in the target time-frequency resource.

In one embodiment, the first information block is used to indicate an identity adopted by a reference signal transmitted in the target time-frequency resource.

In one embodiment, the first information block is used to indicate an index adopted by a reference signal transmitted in the target time-frequency resource.

In one embodiment, the target time-frequency resource occupies more than one positive integer number of REs (Resource Elements).

In one embodiment, the target time-frequency resource is used to transmit a CSI-RS.

In one embodiment, the target time-frequency resource is used to transmit a reference signal.

In one embodiment, the target time-frequency resource is a CSI resource.

In one embodiment, the target time-frequency resource is a NZP CSI-RS resource, or an SSB (Synchronization Signal/Physical Broadcast Channel block) resource indicated by an ssb-Index.

In one embodiment, the first information block is used to indicate a CSI-RS resource set corresponding to the first time-frequency resource set.

In one embodiment, the first information block is used to indicate time-frequency resources occupied by the first time-frequency resource set.

In one embodiment, the first information block is used to indicate a CSI-ResourceConfigId adopted by a reference signal transmitted in each of the K1 first-type time-frequency resources.

In one embodiment, the first information block is used to indicate an identity adopted by a reference signal transmitted in each of the K1 first-type time-frequency resources.

In one embodiment, the first information block is used to indicate an identifier adopted by a reference signal transmitted in each of the K1 first-type time-frequency resources.

In one embodiment, the first information block is used to indicate CSI-RS resources corresponding to each of the K1 first-type time-frequency resources.

In one embodiment, each of the K1 first-type time-frequency resources is used to transmit a CSI-RS.

In one embodiment, each of the K1 first-type time-frequency resources is used to transmit a reference signal.

In one embodiment, at least one of the K1 first-type time-frequency resources is used to transmit a reference signal.

In one embodiment, each of the K1 first-type time-frequency resources occupies more than one positive integer number of REs.

In one embodiment, each of the K1 first-type time-frequency resources is a CSI resource.

In one embodiment, each of the K1 first-type time-frequency resources is an NZP CSI-RS resource, or an SSB resource indicated by an ssb-Index.

In one embodiment, the meaning of the above phrase that the target time-frequency resource is associated with each of the K1 first-type time-frequency resources comprises: the target time-frequency resource is a target reference signal resource, the K1 first-type time-frequency resources are respectively K1 first-type reference signal resources, and a reference signal transmitted in the target reference signal resource follows a QCLed relation of type D with a reference signal transmitted in any of the K1 first-type reference signal resources.

In one embodiment, the meaning of the above phrase that the target time-frequency resource is associated with each of the K1 first-type time-frequency resources comprises: the target time-frequency resource is a target reference signal resource, the K1 first-type time-frequency resources are respectively K1 first-type reference signal resources, and a reference signal transmitted in the target reference signal resource is QCLed with a reference signal transmitted in any of the K1 first-type reference signal resources.

In one embodiment, the meaning of the above phrase that the target time-frequency resource is associated with each of the K1 first-type time-frequency resources comprises: the first node uses same Spatial Rx parameters to receive a radio signal transmitted in the target time-frequency resources, as well as a radio signal transmitted from any of the K1 first-type reference signal resources.

In one embodiment, the meaning of the above phrase that the target time-frequency resource is associated with each of the K1 first-type time-frequency resources comprises: the target time-frequency resource is a target reference signal resource, the K1 first-type time-frequency resources are respectively K1 first-type reference signal resources, and a reference signal transmitted in the target reference signal resource follows a QCLed relation of type D with a reference signal transmitted in at least one of the K1 first-type reference signal resources.

In one embodiment, the meaning of the above phrase that the target time-frequency resource is associated with each of the K1 first-type time-frequency resources comprises: the target time-frequency resource is a target reference signal resource, the K1 first-type time-frequency resources are respectively K1 first-type reference signal resources, and a reference signal transmitted in the target reference signal resource is QCLed with a reference signal transmitted in at least one of the K1 first-type reference signal resources.

In one embodiment, a radio signal transmitted in the target time-frequency resource and a radio signal transmitted in the target first-type time-frequency resource are QCLed.

In one embodiment, a reference signal transmitted in the target time-frequency resource and a reference signal transmitted in the target first-type time-frequency resource are QCLed.

In one embodiment, Spatial Rx parameters of the target time-frequency resource are determined by Spatial Rx parameters of the target first-type time-frequency resource.

Typically, each of the K1 first-type time-frequency resources is one of an SSB indicated by ssb-Index or CSI-RS resources; the target time-frequency resource is one of an SSB indicated by ssb-Index, CSI-RS resources, or CSI-IM (Channel State Information Interference Measurement) resources.

In one embodiment, the first measurement information set only occupies a physical-layer channel.

In one subembodiment of the embodiment, the physical-layer channel is a PUCCH (Physical Uplink Control Channel).

In one subembodiment of the embodiment, the physical-layer channel is a PUSCH (Physical Uplink Shared Channel).

In one embodiment, the first measurement information set comprises UCI (Uplink Control Information).

In one embodiment, the first resource indicator is a CRI (CSI-RS Resource Indicator).

In one embodiment, the first resource indicator is an SSBRI (SSB Resource Indicator).

In one embodiment, the first measurement information set comprises a first CQI, and an interference measurement performed on the target time-frequency resources is used to determine the first CQI.

Typically, the interference measurement performed on the target time-frequency resource comprises a measurement performed on a radio signal used for inter-base station radio interaction transmitted to a serving cell.

In one embodiment, the interference measurement performed on the target time-frequency resource comprises measuring a reference signal transmitted by a non-serving cell.

In one embodiment, the first measurement information set comprises a first CQI, and a channel measurement performed on the target first-type time-frequency resources is used to determine the first CQI.

In one embodiment, a type of the CSI resources is periodic or semi-persistent.

In one embodiment, how to calculate a first CQI is related to the receiver algorithm of the first node, for example, determined based on BLER (Block Error Rate) vs. White Noise (dB) curve.

In one embodiment, the first node first preprocesses results of a channel measurement and an interference measurement, and then determines the first CQI by looking up a table.

In one embodiment, the preprocessing comprises decomposing an MIMO (Multiple Input Multiple Output) channel into Eigen-Channels.

In one embodiment, the preprocessing comprises whitening interference.

In one embodiment, the first CQI is a largest CQI index that satisfies the following conditions: under the conditions of using an MCS (Modulation and Coding scheme) and TBS (Transport Block Size) indicated by a CQI index and occupying CSI reference resources, an error probability of a transport block does not exceed a specific threshold.

In one embodiment, the specific threshold is 0.1.

In one embodiment, the specific threshold is 0.00001.

In one embodiment, the first information block is used to indicate the first power offset value.

In one embodiment, the first power offset value is measured by dB.

In one embodiment, the first power offset value is a power difference between an RE occupied by a radio signal transmitted in the target time-frequency resource and an RE occupied by the benchmark signal.

In one subembodiment of the embodiment, the benchmark signal comprises at least one of a PSS (Primary synchronization signal) or an SSS (Secondary synchronization signal).

In one subembodiment of the embodiment, the benchmark signal comprises an SSS.

In one subembodiment of the embodiment, the benchmark signal comprises an SSB.

In one embodiment, the first power offset value is a power difference between an RE occupied by the benchmark signal and an RE occupied by a radio signal transmitted in the target time-frequency resource.

In one subembodiment of the embodiment, the benchmark signal comprises a PDSCH (Physical Downlink Shared Channel).

In one subembodiment of the embodiment, the benchmark signal comprises a PBSCH (Physical Backhaul Shared Channel).

In one embodiment, the first power offset value is equal to a difference of a power value of an RE occupied by a radio signal transmitted in the target time-frequency resource minus a power value of an RE occupied by the benchmark signal.

In one embodiment, the first power offset value is equal to a difference of a power value of an RE occupied by the benchmark signal minus a power value of an RE occupied by a radio signal transmitted in the target time-frequency resource.

### Embodiment 2

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NR-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NR-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 supports Unpaired Spectrum scenario.

In one embodiment, the UE 201 supports Flexible Duplex frequency-domain resource configuration.

In one embodiment, the UE 201 supports Full Duplex transmission.

In one embodiment, the UE 201 supports dynamically adjusting uplink and downlink transmission directions.

In one embodiment, the UE 201 supports a reception method based on beamforming.

In one embodiment, the gNB 203 corresponds to the second node in the present application.

In one embodiment, the gNB 204 corresponds to the third node in the present application.

In one embodiment, the gNB 203 or the gNB 204 supports Unpaired Spectrum scenario.

In one embodiment, the gNB 203 or the gNB 204 supports Flexible Duplex frequency-domain resource configuration.

In one embodiment, the gNB 203 or the gNB 204 supports Full Duplex transmission.

In one embodiment, the gNB 203 or the gNB 204 supports dynamically adjusting uplink and downlink transmission directions.

In one embodiment, the gNB 203 or the gNB 204 supports beamforming-based transmission method.

In one embodiment, the first node in the present application corresponds to the UE 201, the second node in the present application corresponds to the gNB 203, and the third node in the present application corresponds to the gNB 204.

In one subembodiment of the embodiment, the gNB 203 and gNB 204 interact through a backhaul link.

In one subembodiment of the embodiment, the gNB 203 and gNB 204 interact through a radio interface.

In one subembodiment of the embodiment, a reference signal transmitted in the target time-frequency resource in the present application is used by the UE 201 to monitor interferences to the UE 201 incurred by a radio signal that the gNB 203 interacts with the gNB 204 via a radio interface.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first information block is generated by the RRC 306.

In one embodiment, the first information block is generated by the MAC 302 or the MAC 352.

In one embodiment, the first measurement information set is generated by the PHY 301 or the PHY 351.

In one embodiment, the first measurement information set is generated by the MAC 302 or MAC 352.

In one embodiment, the first measurement information set is generated by the RRC 306.

In one embodiment, the first node is a terminal.

In one embodiment, the first node is a relay.

In one embodiment, the second node is a relay.

In one embodiment, the second node is a base station.

In one embodiment, the second node is a gNB.

In one embodiment, the second node is a Transmitter Receiver Point (TRP).

In one embodiment, the second node is used to manage multiple TRPs.

In one embodiment, the second node is a node used for managing multiple cells.

In one embodiment, the second node is a node used for managing multiple carriers.

### Embodiment 4

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: first receives a first information block, the first information block is used to determine a target time-frequency resource and a first time-frequency resource set, the first time-frequency resource set comprises K1 first-type time-frequency resources, the target time-frequency resource is associated with each of the K1 first-type time-frequency resources; then transmits a first measurement information set; an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

In one embodiment, the first communication device 450 comprises at least one processor and at least one memory. a memory that stores a computer readable instruction program. The computer readable instruction program generates an action when executed by at least one processor. The action includes: first receiving a first information block, the first information block being used to determine a target time-frequency resource and a first time-frequency resource set, the first time-frequency resource set comprising K1 first-type time-frequency resources, the target time-frequency resource being associated with each of the K1 first-type time-frequency resources; then transmitting a first measurement information set; an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: first transmits a first information block, the first information block is used to determine a target time-frequency resource and a first time-frequency resource set, the first time-frequency resource set comprises K1 first-type time-frequency resources, the target time-frequency resource is associated with each of the K1 first-type time-frequency resources; then receives a first measurement information set; an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

In one embodiment, the second communication device 410 comprises a memory that stores a computer readable instruction program. The computer readable instruction program generates an action when executed by at least one processor. The action includes: first transmitting a first information block, the first information block being used to determine a target time-frequency resource and a first time-frequency resource set, the first time-frequency resource set comprising K1 first-type time-frequency resources, the target time-frequency resource being associated with each of the K1 first-type time-frequency resources; then receiving a first measurement information set; an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the first communication device 450 is a relay.

In one embodiment, the second communication device 410 is a base station.

In one embodiment, the second communication device 410 is a relay.

In one embodiment, the second communication device 410 is a network device.

In one embodiment, the second communication device 410 is a serving cell.

In one embodiment, the second communication device 410 is a TRP.

In one embodiment, at least first four of the antenna 452, the receiver 454, the multi-antenna receiving processor 458, the receiving processor 456 and the controller/processor 459 are used to receive a first information block; at least first four of the antenna 420, the transmitter 418, the multi-antenna transmitting processor 471, the transmitting processor 416 and the controller/processor 475 are used to transmit a first information block.

In one embodiment, at least first four of the antenna 452, the transmitter 454, the multi-antenna transmitting processor 457, the transmitting processor 468, and the controller/processor 459 are used to transmit a first measurement information set; at least first four of the antenna 420, the receiver 418, the multi-antenna receiving processor 472, the receiving processor 470 and the controller/processor 475 are used to receive a first measurement information set.

In one embodiment, at least first four of the antenna 452, the receiver 454, the multi-antenna receiving processor 458, the receiving processor 456 and the controller/processor 459 are used to determine the target first-type time-frequency resource from the K1 first-type time-frequency resources.

In one embodiment, at least first four of the antenna 452, the receiver 454, the multi-antenna receiving processor 458, the receiving processor 456 and the controller/processor 459 are used to receive a target signal and K1 first-type signals; at least first four of the antenna 420, the transmitter 418, the multi-antenna transmitting processor 471, the transmitting processor 416 and the controller/processor 475 are used to transmit a target signal and K1 first-type signals.

In one embodiment, at least first four of the antenna 452, the receiver 454, the multi-antenna receiving processor 458, the receiving processor 456 and the controller/processor 459 are used to K1 second-type signals; at least first four of the antenna 420, the transmitter 418, the multi-antenna transmitting processor 471, the transmitting processor 416 and the controller/processor 475 are used to K1 second-type signals.

### Embodiment 5

Embodiment 5 illustrates a flowchart of a first information block, as shown in FIG. 5. In FIG. 5, a first node U1 and a second node N2 are in communications via a radio link. It is particularly underlined that the order illustrated in the embodiment does not put constraints over sequences of signal transmissions and implementations. Embodiments, sub-embodiments and subsidiary embodiments of embodiment 5 can be applied to embodiments 6, 7 and 8 without conflict; on the contrary, embodiments, sub-embodiments and subsidiary embodiments of embodiments 6, 7 and 8 can be applied to embodiment 5 without conflict.

The first node U1 receives a first information block in step S10; transmits a first measurement information set in step S11.

The second node N2 transmits a first information block in step S20; receives a first measurement information set in step S21.

In embodiment 5, the first information block is used to determine a target time-frequency resource and a first time-frequency resource set, the first time-frequency resource set comprises K1 first-type time-frequency resources, the target time-frequency resource is associated with each of the K1 first-type time-frequency resources; an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

In one embodiment, the first information block is used to determine a second time-frequency resource set, the second time-frequency resource set comprises K1 second-type time-frequency resources, and the K1 first-type time-frequency resources are respectively associated with the K1 second-type time-frequency resources; the target first-type time-frequency resource is associated with a target second-type time-frequency resource in the K1 second-type time-frequency resources, and an interference measurement performed on the target second-type time-frequency resource is used to determine the first measurement information set.

In one subembodiment of the embodiment, the first information block is used to indicate a CSI-RS resource set corresponding to the second time-frequency resource set.

In one subembodiment of the embodiment, the first information block is used to indicate time-frequency resources occupied by the second time-frequency resource set.

In one subembodiment of the embodiment, the first information block is used to indicate a CSI-ResourceConfigId adopted by a reference signal transmitted in each of the K1 second-type time-frequency resources.

In one subembodiment of the embodiment, the first information block is used to indicate an identity adopted by a reference signal transmitted in each of the K1 second-type time-frequency resources.

In one subembodiment of the embodiment, the first information block is used to indicate an identifier adopted by a reference signal transmitted in each of the K1 second-type time-frequency resources.

In one subembodiment of the embodiment, the first information block is used to indicate CSI-RS resources corresponding to each of the K1 second-type time-frequency resources.

In one subembodiment of the embodiment, each of the K1 second-type time-frequency resources is used to transmit a CSI-RS.

In one subembodiment of the embodiment, each of the K1 second-type time-frequency resources is used to transmit a reference signal.

In one subembodiment of the embodiment, at least one of the K1 second-type time-frequency resources is used to transmit a reference signal.

In one subembodiment of the embodiment, each of the K1 second-type time-frequency resources occupies more than one positive integer number of REs.

In one subembodiment of the embodiment, each of the K1 second-type time-frequency resources is a CSI resource.

In one subembodiment of the embodiment, each of the K1 second-type time-frequency resources is an NZP CSI-RS resource, or an SSB resource indicated by an ssb-Index.

In one subembodiment of the embodiment, the meaning of the above phrase that the K1 first-type time-frequency resources are respectively associated with K1 second-type time-frequency resources comprises: the K1 first-type time-frequency resources are respectively K1 first-type reference signal resources, and the K1 second-type time-frequency resources are respectively K1 second-type reference signal resources; K1 reference signals transmitted in K1 first-type reference signal resources are respectively QCLed with K1 reference signals transmitted in the K2 first-type reference signal resources.

In one subembodiment of the embodiment, the meaning of the above phrase that the K1 first-type time-frequency resources are respectively associated with K1 second-type time-frequency resources comprises: a first-type radio signal is a radio signal transmitted on any of the K1 first-type time-frequency resources, and first-type time-frequency resources occupied by the first-type radio signal are associated with a given second-type time-frequency resource in the K1 second-type time-frequency resources; the first node adopts same Spatial Rx parameters to receive the first-type radio signal and a radio signal transmitted from the given second-type time-frequency resource.

In one subembodiment of the embodiment, the first measurement set comprises a first CQI.

In one subembodiment of the embodiment, the first time-frequency resource set and the second time-frequency resource set are used to measure other interference signals at the same time, and the other interference signals are used to calculate the first CQI.

In one subembodiment of the embodiment, the target first-type time-frequency resource and the target second-type time-frequency resource are used to measure other interference signals, and the other interference signals are used to calculate the first CQI.

In one subembodiment of the embodiment, the other interferences comprise background noise.

In one subembodiment of the embodiment, the other interferences comprise interferences incurred by a signal transmitted by a base station other than the second node.

In one subembodiment of the embodiment, the other interferences comprise interferences from radio systems other than of cellular network.

In one subembodiment of the embodiment, the other interferences comprise interferences from a link other than a Uu link.

In one subembodiment of the embodiment, how to specifically determine how the first CQI is determined by the receiving algorithm of the second node N2.

Typically, the target second-type time-frequency resource is used to measure interferences from the Interference Transmission Layer.

In one subembodiment of the embodiment, a number of second-type time-frequency resource(s) comprised in the second time-frequency resource set is the same as a number of first-type time-frequency resource(s) comprised in the first time-frequency resource set.

In one subsidiary embodiment of the subembodiment, according to a position order in the second time-frequency resource set and a position order in the first time-frequency resource set, the second-type time-frequency resource corresponds one-to-one with a first-type time-frequency resource.

In one subembodiment of the embodiment, the second time-frequency resource set is a CSI resource set.

In one subembodiment of the embodiment, any second-type time-frequency resource in the second time-frequency resource set is either a CSI-IM resource or a CSI-RS resource.

In one subembodiment of the embodiment, any second-type time-frequency resource in the second time-frequency resource set is configured by csi-IM-Resource or nzp-CSI-RS-Resources.

Typically, any second-type time-frequency resource in the second time-frequency resource set is associated with an SSB of a first cell or a CSI-RS resource, or is a CSI-IM resource; at least one first-type time-frequency resource in the first time-frequency resource set is associated with the first cell.

In one subembodiment of the embodiment, all first-type time-frequency resources in the first time-frequency resource set are associated with the first cell.

In one subembodiment of the embodiment, the first information block indicates a type of CSIs comprised in the first measurement information set.

In one subembodiment of the embodiment, the type of CSIs comprised in the first measurement information set is indicated by reportQuantity in the first information block.

In one embodiment, the Spatial Rx parameters comprise an analog beamforming vector.

In one embodiment, the Spatial Rx parameters comprise a digital beamforming vector.

In one embodiment, the Spatial Rx parameters comprise spatial filtering parameters.

In one embodiment, the QCL refers to Quasi Co-Located.

In one embodiment, the QCL refers to Quasi Co-Location.

In one embodiment, the QCL comprises a QCL parameter.

In one embodiment, the QCL comprises a QCL assumption.

In one embodiment, a type of the QCL comprises QCL-TypeA.

In one embodiment, a type of the QCL comprises QCL-TypeB.

In one embodiment, a type of the QCL comprises QCL-TypeC.

In one embodiment, a type of the QCL comprises QCL-TypeD.

In one embodiment, a value range of the first power offset is a first set, the first set is one of a first candidate value set and a second candidate value set, and the first candidate value set is different from the second candidate value set.

In one subembodiment of the embodiment, the first set comprises more than one positive integer number of candidate values.

In one subsidiary embodiment of the subembodiment, the candidate value comprised in the first set is measured by dB.

In one subembodiment of the embodiment, the first candidate value set comprises more than one positive integer number of candidate values.

In one subsidiary embodiment of the subembodiment, the candidate value comprised in the first candidate value set is measured by dB.

In one subembodiment of the embodiment, the second candidate value set comprises more than one positive integer number of candidate values.

In one subsidiary embodiment of the subembodiment, the candidate value comprised in the second candidate value set is measured by dB.

In one subembodiment of the embodiment, the meaning of the above phrase that the first candidate value set and the second candidate value set are different comprises: a number of candidate value(s) comprised in the first candidate value set is different from a number of candidate value(s) comprised in the second candidate value set.

In one subembodiment of the embodiment, the meaning of the above phrase that the first candidate value set and the second candidate value set are different comprises: there exists at least one candidate value in all candidate values comprised in the first candidate value set being different from any candidate value in all candidate values comprised in the second candidate value set.

Typically, the meaning of the above phrase that the first candidate value set and the second candidate value set are different comprises: there at least exists a candidate value in the first candidate value set being less than all candidate values in the second candidate value set.

Typically, the meaning of the above phrase that the first candidate value set and the second candidate value set are different comprises: a number of candidate value(s) comprised in the first candidate value set is greater than a number of candidate value(s) comprised in the second candidate value set.

Typically, the meaning of the above phrase that the first candidate value set and the second candidate value set are different comprises: a largest value in the first candidate value set is not greater than 0, and a largest value in the second candidate value set is greater than 0.

In one subembodiment of the embodiment, a field in an IE of an RRC signaling corresponding to the first candidate set comprises powerControlOffset.

In one subembodiment of the embodiment, a field in an IE of an RRC signaling corresponding to the first candidate set comprises powerControlOffsetSS.

In one subembodiment of the embodiment, a field in an IE of an RRC signaling corresponding to the second candidate set comprises powerControlOffset.

In one subembodiment of the embodiment, a field in an IE of an RRC signaling corresponding to the second candidate set comprises powerControlOffsetSS.

In one subembodiment of the embodiment, the first information block simultaneously indicates the first power offset value and the second power offset value, when the second power offset value indicates a power difference of a reference signal transmitted in the target first-type time-frequency resource and an SSS and the first set is the first candidate value set, the second power offset value indicates a power difference of a reference signal transmitted in the target first-type time-frequency resource and a PDSCH and a value range of the second power offset value is the second candidate value set.

In one subembodiment of the embodiment, the first information block simultaneously indicates the first power offset value and a second power offset value, when the second power offset value indicates a power difference of a reference signal transmitted in the target first-type time-frequency resource and a PDSCH and the first set is the first candidate value set, the second power offset value indicates a power difference of a reference signal transmitted in the target first-type time-frequency resource and an SSS and a value range of the second power offset value is the second candidate value set.

In one subembodiment of the embodiment, the first information block simultaneously indicates the first power offset value and a second power offset value, when the second power offset value indicates a power difference of a reference signal transmitted in the target first-type time-frequency resource and a given physical-layer channel and the first set is the first candidate value set, the second power offset value indicates a power difference of a reference signal transmitted in the target first-type time-frequency resource and an SSS and a value range of the second power offset value is the second candidate value set.

In one subsidiary embodiment of the subembodiment, the given physical-layer channel is a PBSCH.

In one subsidiary embodiment of the subembodiment, the given physical-layer channel is used for a radio interface based interaction between base stations.

In one embodiment, the first set is related to a type of resources occupied by a first reference time-frequency resource; the first reference time-frequency resource and the first time-frequency resource are QCLed.

In one subembodiment of the embodiment, a transmitter of the first information is a second node.

In one subembodiment of the embodiment, when the first reference time-frequency resource is configured as uplink transmission by the second node, or supports dynamic adjustment of uplink and downlink transmission directions, the first set is the first candidate value set; or, when the first reference time-frequency resource is configured by the second node for downlink transmission, the first set is the second candidate value set.

In one subembodiment of the embodiment, the first reference time-frequency resource is used by the first node for a transmission of a radio signal.

In one subembodiment of the embodiment, the first reference time-frequency resource is used for a transmission of a PDSCH.

Typically, when the first reference time-frequency resource is configured by the second node for uplink transmission, the first set is the first candidate value set; or, when the first reference time-frequency resource is configured by the second node for downlink transmission, the first set is the second candidate value set.

Typically, the first reference time-frequency resource is used by the first node for an interaction between the first node and other base stations.

Typically, the first reference time-frequency resource is used by the first node for the transmission of a backhaul link.

Typically, the first reference time-frequency resource is used by the first node for wireless Xn interface transmission.

In one embodiment, a value range of the first power offset value is a first candidate value set, the first information block also indicates a target power offset value, the target power offset value indicates a power difference of a reference signal transmitted in the target first-type time-frequency resource and a PDSCH, and a value range of the target power offset value is a second candidate value set; the first candidate value set is different from the second candidate value set.

In one subembodiment of the embodiment, when the first information block also indicates the target power offset value, a field in an IE of an RRC signaling corresponding to the first candidate set comprises powerControlOffsetSS, and a field in an IE of an RRC signaling corresponding to the second candidate set comprises powerControlOffset.

In one subembodiment of the embodiment, when the first information block also indicates a target power offset value, the benchmark signal comprises a synchronization signal.

In one subembodiment of the embodiment, the target power offset value is measured by dB.

In one subembodiment of the embodiment, the target power offset value is a power offset value corresponding to a reference signal transmitted in the target first-type time-frequency resource among the K1 power offset values.

Typically, the first information block indicates K1 power offset values, the K1 power offset values respectively indicate power differences of reference signals transmitted in the K1 first-type time-frequency resources and a PDSCH, and a value range for each of the K1 power offset values is the second candidate value set.

In one embodiment, the K1 first-type time-frequency resources comprises at least one periodic NZP CSI-RS resource, compared to any the periodic NZP CSI-RS resource in the K1 first-type time-frequency resources, configuration information of the target time-frequency resource indicated by the first information block lacks a first field, and the first field is used to indicate QCL parameters.

In one subembodiment of the embodiment, a name of a field in an RRC IE corresponding to the first field comprises qcl-InfoPeriodicCSI-RS.

In one subembodiment of the embodiment, a name of a field in an RRC IE corresponding to the first field comprises qcl-Info.

In one subembodiment of the embodiment, a name of a field in an RRC IE corresponding to the first field comprises PeriodicCSI-RS.

Typically, the first field is TCI-StateId.

### Embodiment 6

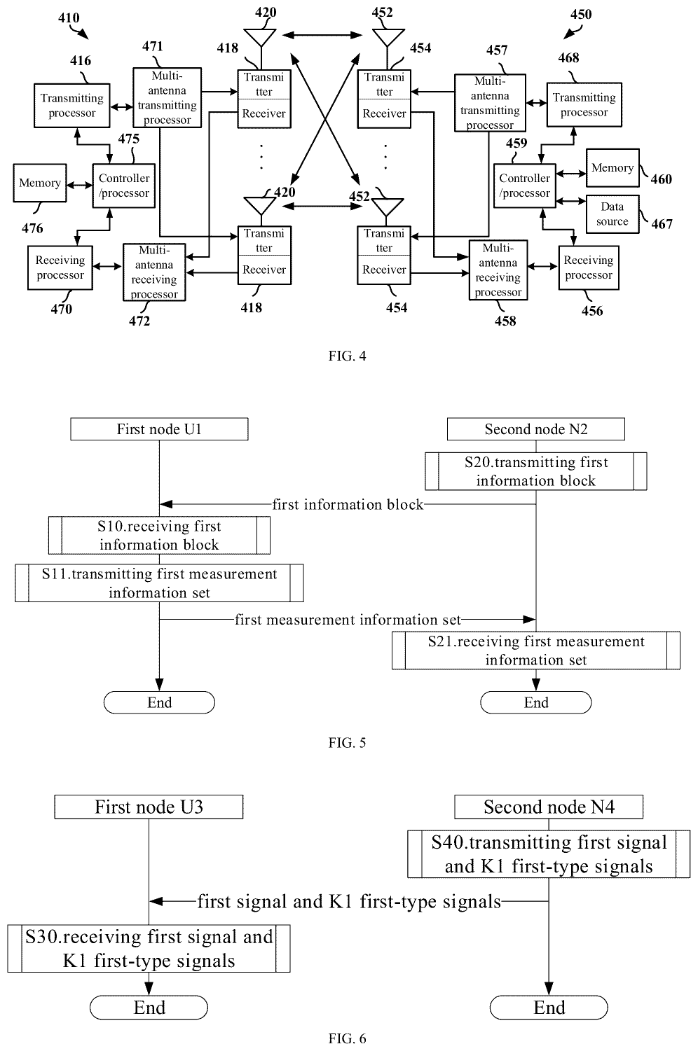

Embodiment 6 illustrates a flowchart of a first signal and K1 first-type signals, as shown in FIG. 6. In FIG. 6, a first node U3 and a second node N4 are in communications via a radio link. It is particularly underlined that the order illustrated in the embodiment does not put constraints over sequences of signal transmissions and implementations. Embodiments, sub-embodiments and subsidiary embodiments of embodiment 6 can be applied to embodiment 5, 7 and 8 if no conflict is incurred; on the contrary, embodiments, sub-embodiments and subsidiary embodiments of embodiments 5, 7 and 8 can be applied to embodiment 6 without conflict.

The first node U3 receives a first signal and K1 first-type signals in step S30.

The second node N4 transmits a first signal and K1 first-type signals in step S40.

In embodiment 6, the first signal occupies the target time-frequency resource, and the K1 first-type signals occupy the K1 first-type time-frequency resources respectively.

In one embodiment, the first signal is a radio signal.

In one embodiment, the first signal is a baseband signal.

In one embodiment, the first signal is a CSI-RS.

In one embodiment, any of the K1 first-type signals is a radio signal.

In one embodiment, any of the K1 first-type signals is a baseband signal.

In one embodiment, any of the K1 first-type signals is a CSI-RS.

In one embodiment, the step S30 is taken after the step S10 and before the step S11 in embodiment 5.

In one embodiment, the step S40 is taken after the step S20 and before the step S21 in embodiment 5.

### Embodiment 7

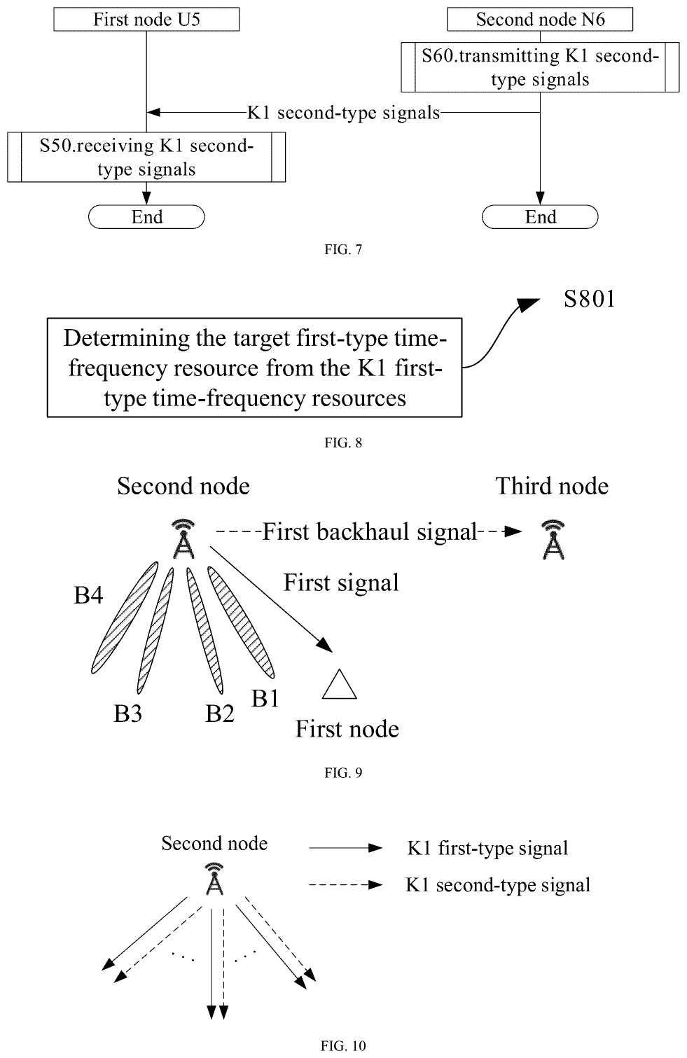

Embodiment 7 illustrates a flowchart of K1 second-type signals, as shown in FIG. 7. In FIG. 7, a first node U5 and a second node N6 are in communications via a radio link. It is particularly underlined that the order illustrated in the embodiment does not put constraints over sequences of signal transmissions and implementations. Embodiments, sub-embodiments and subsidiary embodiments of embodiment 7 can be applied to embodiment 5, 6 and 8 if no conflict is incurred; on the contrary, embodiments, sub-embodiments and subsidiary embodiments of embodiments 5, 6 and 8 can be applied to embodiment 7 without conflict.

The first node U5 receives K1 second-type signals in step S50.

The second node N6 transmits K1 second-type signals in step S60.

In embodiment 7, the K1 second-type signals respectively occupy the K1 second-type time-frequency resources.

In one embodiment, any of the K1 second-type signals is a radio signal.

In one embodiment, any of the K1 second-type signals is a baseband signal.

In one embodiment, any of the K1 second-type signals is a CSI-RS.

In one embodiment, the K1 first-type signals are respectively QCLed with the K1 second-type signals.

In one embodiment, the step S50 is taken after the step S10 and before the step S11 in embodiment 5.

In one embodiment, the step S60 is taken after the step S20 and before the step S21 in embodiment 5.

In one embodiment, the step S50 is taken after the step S30 in Embodiment 6.

In one embodiment, the step S60 is taken after the step S40 in Embodiment 6.

In one embodiment, the step S50 is taken before the step S30 in Embodiment 6.

In one embodiment, the step S60 is taken before the step S40 in Embodiment 6.

### Embodiment 8

Embodiment 8 illustrates a flowchart a target first-type time-frequency resource according to one embodiment of the present application, as shown in FIG. 8. Step S801 in FIG. 8 is executed in a first node. It is particularly underlined that the order illustrated in the embodiment does not put constraints over sequences of signal transmissions and implementations. Embodiments, sub-embodiments and subsidiary embodiments of embodiment 8 can be applied to embodiment 5, 6 and 7 if no conflict is incurred; on the contrary, embodiments, sub-embodiments and subsidiary embodiments of embodiments 5, 6 and 7 can be applied to embodiment 8 without conflict.

The first node U7 determines the target first-type time-frequency resource from the K1 first-type time-frequency resources in step S801.

In Embodiment 8, the target first-type time-frequency resource is one of the K1 first-type time-frequency resources.

In one embodiment, the target first-type time-frequency resource is a first-type time-frequency resource producing a strongest interference amount to a radio signal transmitted in the target time-frequency resource measured among the K1 first-type time-frequency resources; the first resource indication is used to indicate the target candidate resource set.

Typically, how the target first-type time-frequency resource is determined from the K1 first-type time-frequency resources is dependent on the implementation of the first node, and several non-limiting implementation methods are given below.

In one embodiment, the first node randomly selects a first-type time-frequency resource from the K1 first-type time-frequency resources as the target first-type time-frequency resource.

In one embodiment, the first node obtains a first-type time-frequency resource with a smallest CQI index as the target first-type time-frequency resource based on an interference amount measured in the target time-frequency resource combined with RSRP (Reference Signal Received Power) calculated in each of the K1 first-type time-frequency resources.

In one embodiment, the interference amount comprises RSRP.

In one embodiment, the interference amount comprises RSRQ (Reference Signal Received Quality).

In one embodiment, the interference amount comprises SINR (Signal to Interference Noise Ratio).

In one embodiment, the step S801 is taken before the step S11 in Embodiment 5.

In one embodiment, the step S801 is taken after the step S30 in Embodiment 6.

In one embodiment, the step S801 is taken after the step S50 in Embodiment 6.

### Embodiment 9

Embodiment 9 illustrates a schematic diagram of a first measurement information set, as shown in FIG. 9. In FIG. 9, a first time-frequency resource set comprises four first-type time-frequency resources, and the first node respectively uses spatial reception parameter groups B1, B2, B3, and B4 to receive reference signals on the four first-type time-frequency resources.

A first resource indication fed back by the first node is used to indicate spatial transmission parameter group B1, i.e., the target first-type time-frequency resource, from the four first-type time-frequency resources.

A second node determines first backhaul information based on at least the first resource, and then transmits the first backhaul signaling to the third node through an air interface.

A channel measurement on the target first-type time-frequency resource adopting spatial reception parameter group B1 and an interference measurement on the target time-frequency resource are used to calculate a first CQI, and the first CQI is used to generate the first measurement information set; the target time-frequency resource is used to transmit a first signal; the second node avoids adopting a spatial transmission parameter group corresponding to spatial reception parameter group B1 when transmitting the first backhaul signaling at the air interface, thereby significantly reducing the interference of the first backhaul signaling on the cellular link.

In one embodiment, each spatial transmission parameter group is indexed by a TCI-state.

In one embodiment, each spatial transmission parameter group is indexed by an ssb-index.

In one embodiment, each spatial reception parameter group is indexed by a TCI-state.

In one embodiment, each spatial reception parameter group is indexed by an ssb-index.

In one embodiment, on the target time-frequency resource, the first node adopts a spatial transmission parameter group corresponding to a spatial reception parameter group B1 to transmit V2X signals.

In one embodiment, there exists a wired backhaul link L1 between the second node and the third node, and before transmitting the first information block, the second node and the third node make necessary configurations through a wired backhaul link L1.

In one embodiment, the necessary configuration comprises the target time-frequency resource.

In one embodiment, the necessary configuration comprises the first time-frequency resource set.

In one embodiment, the necessary configuration comprises the second time-frequency resource set.

In one embodiment, the necessary configuration comprises time-frequency resources occupied by the first backhaul signaling.

In one embodiment, the wired backhaul link L1 supports an Xn interface.

### Embodiment 10

Embodiment 10 illustrates a schematic diagram of K1 second-type signals, as shown in FIG. 10. In FIG. 10, the K1 second-type time-frequency resources are respectively associated with the K1 first-type time-frequency resources; the K1 second-type time-frequency resources are respectively used to transmit the K1 second-type signals illustrated in the figure, and the K1 first-type time-frequency resources are respectively used to transmit the K1 first-type signals illustrated in the figure; the K1 second-type signals are respectively QCLed with the K1 first-type signals.

In one embodiment, a given first-type signal is any of the K1 first-type signals, and the given first-type signal is associated with a given second-type signal in the K1 second-type signals.

In one subembodiment of the above embodiment, the given first-type signal is used for channel measurement, and the given second-type signal is used for interference measurement.

In one subembodiment of the above embodiment, the first node adopts a same spatial reception parameter group to receive the given first-type signal and the given second-type signal.

In one subembodiment of the above embodiment, the second node adopts a same spatial reception parameter group to receive the given first-type signal and the given second-type signal.

In one subembodiment of the above embodiment, the given first-type signal and the given second-type signal correspond to a same TCI-State-ID.

### Embodiment 11

Embodiment 11 illustrates a schematic diagram of a first candidate value set and a second candidate value set, as shown in FIG. 11. A first candidate value set shown in the figure comprises M1 first-type candidate values, respectively corresponding to first-type candidate values #1 to first-type candidate value #M1 in the figure; the second candidate value set shown in the figure comprises M2 second-type candidate values, respectively corresponding to second-type candidate value #1 to second-type candidate value #M2 in the figure.

In one embodiment, the M1 first-type candidate value and the M2 second-type candidate value are both used to represent a power difference of an RE occupied by a reference signal transmitted in the target time-frequency resource and an SSS; M1 and M2 are both positive integers greater than 1.

In one subembodiment of the embodiment, when the first reference time-frequency resource is configured by the second node used for uplink transmission, the first candidate value set is used to determine a power difference of an RE occupied by a reference signal transmitted in the target time-frequency resource and an SSS; when the first reference time-frequency resource is configured by the second node used for downlink transmission, the second candidate value set is used to determine a power difference of an RE occupied by a reference signal transmitted in the target time-frequency resource and an SSS.

In one embodiment, M1 is equal to the M2.

In one embodiment, a field of an RRC IE configuring the first candidate value set and the second candidate value set comprises powerControlOffsetSS.

In one embodiment, a field of an RRC IE configuring the first candidate value set comprises powerControlOffsetSS-1, and a field of an RRC IE configuring the second candidate value set comprises powerControlOffsetSS-2.

In one embodiment, a field of an RRC IE configuring the first candidate value set comprises powerControlOffsetSS-backhaul, and a field of an RRC IE configuring the second candidate value set comprises powerControlOffsetSS-Uu.

### Embodiment 12

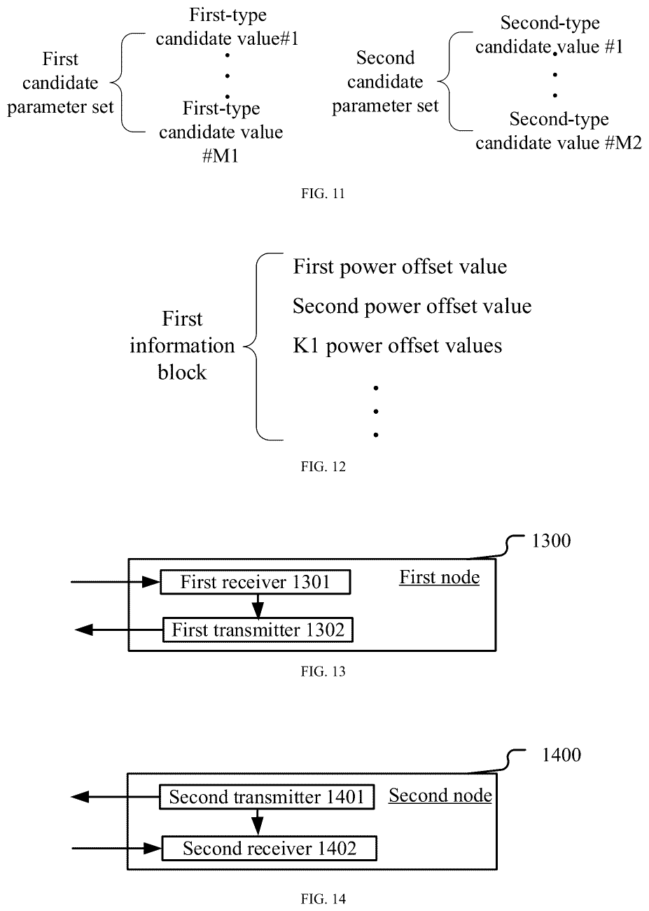

Embodiment 12 illustrates a schematic diagram of a first information block, as shown in FIG. 12. A first information block shown in the figure comprises a first power offset value, a second power offset value, and K1 power offset values; the first power offset value is used to indicate a power difference of a reference signal transmitted in the target time-frequency resource and an SSS, and the second power offset value is used to indicate a power difference of a PDSCH and a reference signal transmitted in the target time-frequency resource, and the K1 power offset values respectively indicate power differences of reference signals transmitted in the K1 first-type time-frequency resources and a PDSCH.

In one embodiment, a value range for the first power offset value is the first candidate value set.

In one embodiment, a value range for the second power offset value is the second candidate value set.

In one embodiment, a value range for each of the K1 power offset values is the second candidate value set.

In one embodiment, the first candidate value set is different from a power offset value indicated by a PowerControlOffsetSS field of an RRC IE.

In one embodiment, the second candidate value set is the same as a power offset value indicated by a PowerControlOffset field of an RRC IE.

### Embodiment 13

Embodiment 13 illustrates a structure block diagram in a first node, as shown in FIG. 13. In FIG. 13, a first node 1300 comprises a first receiver 1301 and a first transmitter 1302.

The first receiver 1301 receives a first information block, the first information block is used to determine a target time-frequency resource and a first time-frequency resource set, the first time-frequency resource set comprises K1 first-type time-frequency resources, and the target time-frequency resource is associated with each of the K1 first-type time-frequency resources;
the first transmitter 1302 transmits a first measurement information set;

In embodiment 13, an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

In one embodiment, the first information block is used to determine a second time-frequency resource set, the second time-frequency resource set comprises K1 second-type time-frequency resources, and the K1 first-type time-frequency resources are respectively associated with the K1 second-type time-frequency resources; the target first-type time-frequency resource is associated with a target second-type time-frequency resource in the K1 second-type time-frequency resources, and an interference measurement performed on the target second-type time-frequency resource is used to determine the first measurement information set.

In one embodiment, a value range of the first power offset is a first set, the first set is one of a first candidate value set and a second candidate value set, and the first candidate value set is different from the second candidate value set.

In one embodiment, the first set is related to a type of resources occupied by a first reference time-frequency resource; the first reference time-frequency resource and the first time-frequency resource are QCLed.

According to one aspect of the present application, a value range of the first power offset value is a first candidate value set, the first information block also indicates a target power offset value, the target power offset value indicates a power difference of a reference signal transmitted in the target first-type time-frequency resource and a PDSCH, and a value range of the target power offset value is a second candidate value set; the first candidate value set is different from the second candidate value set.

According to one aspect of the present application, the K1 first-type time-frequency resources comprises at least one periodic NZP CSI-RS resource, compared to any the periodic NZP CSI-RS resource in the K1 first-type time-frequency resources, configuration information of the target time-frequency resource indicated by the first information block lacks a first field, and the first field is used to indicate QCL parameters.

In one embodiment, the first receiver 1301 receives a first signal and K1 first-type signals; the first signal occupies the target time-frequency resource, and the K1 first-type signals occupy the K1 first-type time-frequency resources respectively.

In one embodiment, the first receiver 1301 receives K1 second-type signals; the K1 second-type signals respectively occupy the K1 second-type time-frequency resources.

In one embodiment, the first receiver 1301 determines the target first-type time-frequency resource from the K1 first-type time-frequency resources; the target first-type time-frequency resource is a first-type time-frequency resource producing a strongest interference amount to a radio signal transmitted in the target time-frequency resource measured among the K1 first-type time-frequency resources; the first resource indication is used to indicate the target candidate resource set.

In one embodiment, the first receiver 1301 comprises at least first four of the antenna 452, the receiver 454, the multi-antenna receiving processor 458, the receiving processor 456 and the controller/processor 459 in Embodiment 4.

In one embodiment, the first transmitter 1302 comprises at least the first four of the antenna 452, the transmitter 454, the multi-antenna transmitting processor 457, the transmitting processor 468 and the controller/processor 459 in Embodiment 4.

### Embodiment 14

Embodiment 14 illustrates a structure block diagram of in a second node, as shown in FIG. 14. In FIG. 14, a second node 1400 comprises a second transmitter 1401 and a second receiver 1402.

The second transmitter 1401 transmits a first information block, the first information block is used to determine a target time-frequency resource and a first time-frequency resource set, the first time-frequency resource set comprises K1 first-type time-frequency resources, and the target time-frequency resource is associated with each of the K1 first-type time-frequency resources;
the second receiver 1402 receives a first measurement information set;
in embodiment 14, an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

In one embodiment, the first information block is used to determine a second time-frequency resource set, the second time-frequency resource set comprises K1 second-type time-frequency resources, and the K1 first-type time-frequency resources are respectively associated with the K1 second-type time-frequency resources; the target first-type time-frequency resource is associated with a target second-type time-frequency resource in the K1 second-type time-frequency resources, and an interference measurement performed on the target second-type time-frequency resource is used to determine the first measurement information set.

In one embodiment, a value range of the first power offset is a first set, the first set is one of a first candidate value set and a second candidate value set, and the first candidate value set is different from the second candidate value set.

In one embodiment, the first set is related to a type of resources occupied by a first reference time-frequency resource; the first reference time-frequency resource and the first time-frequency resource are QCLed.

In one embodiment, a value range of the first power offset value is a first candidate value set, the first information block also indicates a target power offset value, the target power offset value indicates a power difference of a reference signal transmitted in the target first-type time-frequency resource and a PDSCH, and a value range of the target power offset value is a second candidate value set; the first candidate value set is different from the second candidate value set.

In one embodiment, the K1 first-type time-frequency resources comprises at least one periodic NZP CSI-RS resource, compared to any the periodic NZP CSI-RS resource in the K1 first-type time-frequency resources, configuration information of the target time-frequency resource indicated by the first information block lacks a first field, and the first field is used to indicate QCL parameters.

In one embodiment, the second node determines a type of resources occupied by the first reference time-frequency resource on its own.

In one embodiment, the second node determines a type of resources occupied by the first reference time-frequency resource based on Xn interaction information from other nodes.

In one embodiment, the second node determines scheduling of the first node based on the first measurement information set.

In one embodiment, the second node determines a resource set used for V2X configured for the first node based on the first measurement information set.

In one embodiment, the second node determines a resource pool used for V2X configured for the first node based on the first measurement information set.

In one embodiment, the second node determines QCL parameters of the first node used for V2X based on the first measurement information set.

In one embodiment, the second transmitter 1401 transmits a first signal and K1 first-type signals; the first signal occupies the target time-frequency resource, and the K1 first-type signals occupy the K1 first-type time-frequency resources respectively.

In one embodiment, the second transmitter 1401 transmits K1 second-type signals; the K1 second-type signals respectively occupy the K1 second-type time-frequency resources.

In one embodiment, the second transmitter 1401 comprises at least first four of the antenna 420, the transmitter 418, the multi-antenna transmitting processor 471, the transmitting processor 414 and the controller/processor 475 in Embodiment 4.

In one embodiment, the second receiver 1402 comprises at least first four of the antenna 420, the receiver 418, the multi-antenna transmitting processor 471, the transmitting processor 416 and the controller/processor 475 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IoT terminals, vehicle-mounted communication equipment, vehicles, cars, RSUs, aircrafts, diminutive airplanes, unmanned aerial vehicles, tele-controlled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS, relay satellites, satellite base stations, space base stations, RSUs, Unmanned Aerial Vehicle (UAV), test devices, for example, a transceiver or a signaling tester simulating some functions of a base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information block, the first information block being used to determine a target time-frequency resource and a first time-frequency resource set, the first time-frequency resource set comprising K1 first-type time-frequency resources, the target time-frequency resource being associated with each of the K1 first-type time-frequency resources; and
a first transmitter, transmitting a first measurement information set;
wherein an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

2. The first node according to claim 1, wherein the first information block is used to determine a second time-frequency resource set, the second time-frequency resource set comprises K1 second-type time-frequency resources, and the K1 first-type time-frequency resources are respectively associated with the K1 second-type time-frequency resources; the target first-type time-frequency resource is associated with a target second-type time-frequency resource in the K1 second-type time-frequency resources, and an interference measurement performed on the target second-type time-frequency resource is used to determine the first measurement information set.

3. The first node according to claim 1, wherein a value range of the first power offset is a first set, the first set is one of a first candidate value set and a second candidate value set, and the first candidate value set is different from the second candidate value set.

4. The first node according to claim 3, wherein the first set is related to a type of resources occupied by a first reference time-frequency resource; the first reference time-frequency resource and the first time-frequency resource are QCLed.

5. The first node according to claim 1, wherein a value range of the first power offset value is a first candidate value set, the first information block also indicates a target power offset value, the target power offset value indicates a power difference of a reference signal transmitted in the target first-type time-frequency resource and a PDSCH, and a value range of the target power offset value is a second candidate value set; the first candidate value set is different from the second candidate value set.

6. The first node according to claim 5, wherein the K1 first-type time-frequency resources comprises at least one periodic Non Zero Power (NZP) CSI-RS (Channel-State Information Reference Signals) resource, compared to any the periodic NZP CSI-RS resource in the K1 first-type time-frequency resources, configuration information of the target time-frequency resource indicated by the first information block lacks a first field, and the first field is used to indicate QCL (Quasi co-location) parameters.

7. The first node according to claim 1, wherein the first receiver receives a first signal and K1 first-type signals; the first signal occupies the target time-frequency resource, and the K1 first-type signals respectively occupy the K1 first-type time-frequency resources.

8. The first node according to claim 2, wherein the first receiver receives K1 second-type signals; the K1 second-type signals respectively occupy the K1 second-type time-frequency resources.

9. The first node according to claim 1, wherein the first receiver is used to determine the target first-type time-frequency resource from the K1 first-type time-frequency resources, and the target first-type time-frequency resource is a first-type time-frequency resource producing a strongest interference amount to a radio signal transmitted in the target time-frequency resource measured among the K1 first-type time-frequency resources; the first resource indication is used to indicate the target candidate resource set.

10. The first node according to claim 1, wherein the target time-frequency resource is an NZP CSI-RS resource, or is an SSB resource indicated by an ssb-Index.

11. The first node according to claim 1, wherein the meaning of the above phrase that the target time-frequency resource is associated with each of the K1 first-type time-frequency resources comprises: the target time-frequency resource is a target reference signal resource, the K1 first-type time-frequency resources are respectively K1 first-type reference signal resources, and a reference signal transmitted in the target reference signal resource is QCLed with a reference signal transmitted in any of the K1 first-type reference signal resources.

12. The first node according to claim 1, wherein the interference measurement performed on the target time-frequency resource comprises a measurement performed on a radio signal used for inter-base station radio interaction transmitted by a serving cell.

13. The first node according to claim 1, wherein the interference measurement performed on the target time-frequency resource comprises measuring a reference signal transmitted by a non-serving cell.

14. The first node according to claim 1, wherein the benchmark signal comprises a PDSCH, or the benchmark signal comprises a PBSCH.

15. A second node for wireless communications, comprising:
a second transmitter, transmitting a first information block, the first information block being used to determine a target time-frequency resource and a first time-frequency resource set, the first time-frequency resource set comprising K1 first-type time-frequency resources, the target time-frequency resource being associated with each of the K1 first-type time-frequency resources; and
a second receiver, receiving a first measurement information set;
wherein an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.

16. The second node according to claim 15, wherein the first information block is used to determine a second time-frequency resource set, the second time-frequency resource set comprises K1 second-type time-frequency resources, and the K1 first-type time-frequency resources are respectively associated with the K1 second-type time-frequency resources; the target first-type time-frequency resource is associated with a target second-type time-frequency resource in the K1 second-type time-frequency resources, and an interference measurement performed on the target second-type time-frequency resource is used to determine the first measurement information set.

17. The second node according to claim 15, wherein a value range of the first power offset is a first set, the first set is one of a first candidate value set and a second candidate value set, and the first candidate value set is different from the second candidate value set.

18. The second node according to claim 17, wherein the first set is related to a type of resources occupied by a first reference time-frequency resource; the first reference time-frequency resource and the first time-frequency resource are QCLed.

19. The second node according to claim 15, wherein a value range of the first power offset value is a first candidate value set, the first information block also indicates a target power offset value, the target power offset value indicates a power difference of a reference signal transmitted in the target first-type time-frequency resource and a PDSCH, and a value range of the target power offset value is a second candidate value set; the first candidate value set is different from the second candidate value set.

20. A method in a first node for wireless communications, comprising:
receiving a first information block, the first information block being used to determine a target time-frequency resource and a first time-frequency resource set, the first time-frequency resource set comprising K1 first-type time-frequency resources, the target time-frequency resource being associated with each of the K1 first-type time-frequency resources; and
transmitting a first measurement information set;
wherein an interference measurement performed on the target time-frequency resource is used to determine the first measurement information set; the first measurement information set comprises a first resource indication, and the first resource indication is used to determine a target first-type time-frequency resource in the K1 first-type time-frequency resources; a channel measurement performed on the target first-type time-frequency resource is used to determine the first measurement information set; the first information block is used to determine a first power offset value, and first power offset value is used to indicate a power difference of a reference signal transmitted in the target time-frequency resource and a benchmark signal; K1 is a positive integer greater than 1.
